(19) United States
(12) Patent Application Publication
(10) Pub. No.: US 2024/0284265 A1
(43) Pub. Date: Aug. 22, 2024

(54) DYNAMIC TOGGLING OF VOICE CENTRICITY AND DATA CENTRICITY FOR ROAMING USER EQUIPMENTS

(71) Applicant: T-MOBILE INNOVATIONS LLC, Overland Park, KS (US)

(72) Inventor: Muhammad Tawhidur Rahman, Sammamish, WA (US)

(21) Appl. No.: 18/111,320

(22) Filed: Feb. 17, 2023

(51) Int. Cl. H04W 36/00; H04W 8/06; H04W 36/12

(52) U.S. Cl. CPC H04W 36/0022; H04W 8/06; H04W 36/0027; H04W 36/12

(57) ABSTRACT

Aspects of the disclosure a method, systems, and a non-transitory computer storage media storing computer-useable instructions for dynamic toggling of voice centricity and data centricity for roaming UEs in a network. The method begins with receiving a request to join a network from at least one UE. The network then determines the radio access technology used by the at least one UE requesting to join the network. Based on the radio access technology used by the at least one UE, the network may then instruct the at least one UE to dynamically toggle from voice centricity to data centricity. The network receives confirmation from the at least one UE that the at least one UE has toggled from voice centricity to data centricity.

### BACKGROUND

Voice centricity is defined in the Third Generation Partnership Project (3GPP) standard and is usually hardcoded for handheld user equipment (UE) in a cellular network. The cellular network may be a 2G, 3G, 4G, 5G, or 6G environment. This voice centricity forces UEs to exit a radio network, either home network or visited network, if the network operator deems voice support for a particular radio access technology unavailable in that network. The network may be a Public Land Mobile Network (PLMN). Globally, many network operators are phasing out 2G and 3G networks and shutting down those older technologies as they migrate to Long Term Evolution (LTE) and 5G, and beyond. While many users have updated UEs that are capable of operation on the newest networks, many other users still rely on UEs reliant on older radio access technologies. For those users with older UEs their device may not be capable of remaining on an LTE or 5G network when roaming to another PLMN because the Global System for Mobile Communications (GMS) or Universal Mobile Telecommunications System (UMTS) radios are not available on the roaming network. While the GMS and/or UMTS radios may not be available, LTE data may be available. In those cases, the older UEs may be able to connect using data centricity, but are unable to because the UE remains in a voice centric operation.

### SUMMARY

A high-level overview of various aspects of the present technology is provided in this section to introduce a selection of concepts that are further described below in the detailed description section of this disclosure. This summary is not intended to identify key or essential features of the claimed subject matter, nor is it intended to be used as an aid in isolation to determine the scope of the claimed subject matter.

According to aspects herein, methods, systems, and a non-transitory computer storage media storing computer-useable instructions are provided for dynamic toggling of voice centricity and data centricity for roaming UEs. The network receives a request to join from at least one UE. The network then determines the radio access technology used by the at least one UE requesting to join the network. The UE requesting to join the network may be capable of operating on multiple technologies or may be an older device limited to 2G or 3G capabilities. Based on the radio access technology used by the at least one UE, the network may then instruct the at least one UE to dynamically toggle from voice centricity to data centricity. The network receives confirmation from the at least one UE that the at least one UE has toggled from voice centricity to data centricity.

### BRIEF DESCRIPTION OF THE SEVERAL VIEWS OF THE DRAWINGS

Implementations of the present disclosure are described in detail below with reference to the attached drawing figures, wherein:

FIG. 1 depicts a diagram of an exemplary network environment in which implementations of the present disclosure may be employed, in accordance with aspects herein;

FIG. 2 depicts a cellular network suitable for use in implementations of the present disclosure, in accordance with aspects herein;

FIG. 3 depicts a cellular network with roaming UEs using different radio technologies, in which implementations of the present disclosure may be employed, in accordance with aspects herein;

FIG. 4 is a flow diagram of an exemplary method of dynamic toggling of voice centricity and data centricity for roaming UEs, in an exemplary network environment, in which aspects of the present disclosure may be employed, in accordance with aspects herein; and

FIG. 5 depicts an exemplary computing device suitable for use in implementations of the present disclosure, in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. The following is a list of these acronyms:
3G Third-Generation Wireless Technology
4G Fourth-Generation Cellular Communication System
5G Fifth-Generation Cellular Communication System
6G Sixth-Generation Cellular Communication System
AI Artificial Intelligence
CD-ROM Compact Disk Read Only Memory
CDMA Code Division Multiple Access
eNodeB Evolved Node B
GIS Geographic/Geographical/Geospatial Information System
gNodeB Next Generation Node B
GPRS General Packet Radio Service
GSM Global System for Mobile communications
iDEN Integrated Digital Enhanced Network
IMS Internet Protocol Multimedia System
DVD Digital Versatile Discs
EEPROM Electrically Erasable Programmable Read Only Memory
LED Light Emitting Diode
LTE Long Term Evolution
MIMO Multiple Input Multiple Output
MD Mobile Device
ML Machine Learning
PC Personal Computer
PCS Personal Communications Service
PDA Personal Digital Assistant
PDSCH Physical Downlink Shared Channel
PHICH Physical Hybrid ARQ Indicator Channel
PUCCH Physical Uplink Control Channel
PUSCH Physical Uplink Shared Channel
RAM Random Access Memory
RET Remote Electrical Tilt
RF Radio-Frequency
RFI Radio-Frequency Interference
R/N Relay Node
RNR Reverse Noise Rise
ROM Read Only Memory
RSRP Reference Transmission Receive Power
RSRQ Reference Transmission Receive Quality
RSSI Received Transmission Strength Indicator
SINR Transmission-to-Interference-Plus-Noise Ratio
SNR Transmission-to-noise ratio
SON Self-Organizing Networks
TDMA Time Division Multiple Access
TXRU Transceiver (or Transceiver Unit)
UE User Equipment
UMTS Universal Mobile Telecommunications Systems
VPLMN Visiting Public Land Mobile Network
WCD Wireless Communication Device (interchangeable with UE)

Further, various technical terms are used throughout this description. An illustrative resource that fleshes out various aspects of these terms can be found in Newton's Telecom Dictionary, 25th Edition (2009).

Embodiments of the present technology may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

Different generations of cellular technology have now been used worldwide for decades. Operators around the world are in different phases of technology adoption and migration to new technologies. Operators also have roaming agreements amongst one another to allow customers to roam to a different network, which may be in a different country. Such roaming agreements usually cover older radio access technologies such as GSM (2G), UMTS (3G), and even LTE, as some networks move to 5G, with 6G development occurring rapidly.

Service level roaming capabilities vary with the networks involved, but it is common for the roaming agreements to provide a guarantee of voice service as a first service provided. This is a natural outgrowth of UEs being designed and specified to be voice centric. This voice centricity was defined in the 3GPP standard and provides that if a UE is connecting to a mobile network, being voice centric, the UE needs the assurance that voice calling is supported in the visited PLMN. This may have arisen because voice calling is such a rudimentary service that it should always be assured for a mobile customer. While this philosophy may have held true in the early adoption of mobile cellular technology, it is less so today with the rise of OTT applications that allow voice calls using data service.

Voice centricity is a 3GPP defined logic that is usually hardcoded into UEs using the 2G, 3G, 4G, or 5G environments. This voice centricity logic forces mobile devices to exit a network if a user's UE deems voice support unavailable in the visited PLMN. As many networks are phasing out 2G and 3G networks and shutting down the older radio access technologies as part of the migration to LTE and 5G it is becoming difficult for devices roaming into a new technology network to access network services or remain on the network. When this happens, the UE may not stay on the visited PLMN even though the visited PLMN may have good data availability because the UE is looking for GMS or UMTS voice service. Making a UE dynamically able to switch from voice centricity to data centricity allows the visiting UE to remain on the visited PLMN by toggling from voice centricity to data centricity. Data centricity permits the user to use an application using data, thus providing connectivity in a situation when otherwise the UE could not remain on the visited PLMN. Data calls using applications use an over-the-top (OTT) voice service such as WhatsApp, Facebook Messenger, or similar application.

Aspects discussed below provide for a network to advise a UE to change its voice centricity preference to data centricity if the visited PLMN has shut down an older radio access technology, such as UMTS or GSM. In this situation, the network may be able to be used for data service over LTE. The network would instruct affected UEs to dynamically change from a voice centricity preference to a data centricity preference. This dynamic toggling allows the roaming device to remain on the visited network with no loss of service. More specifically, this may apply to devices that are not capable of voice over LTE (VoLTE) and may also allow visiting from other networks that do not have a VoLTE roaming agreement in place.

In accordance with a first aspect of the present disclosure a method of dynamic toggling of voice centricity and data centricity for roaming UEs in a network is provided. The method begins with receiving a request to join a network from at least one UE. The network then determines the radio access technology used by the at least one UE requesting to join the network. Based on the radio access technology used by the at least one UE, the network may then instruct the at least one UE to dynamically toggle from voice centricity to data centricity. The network receives confirmation from the at least one UE that the at least one UE has toggled from voice centricity to data centricity.

A second aspect of the present disclosure provides a method of dynamic toggling of voice centricity and data centricity for roaming UEs in a network is provided. A UE transmits a request to join the network, wherein the request includes information on a radio access technology used by the UE. Based on the information on the radio access technology used by the UE, the UE then receives an instruction to dynamically toggle from voice centricity to data centricity. The UE then transmits to the network a confirmation that the UE has dynamically toggled from voice centricity to data centricity.

Another aspect of the present disclosure is directed to a non-transitory computer storage media storing computer-useable instructions that, when used by one or more processors, cause the processors to receive a request to join a network from at least one UE. Then the network determines a radio access technology used by the at least one UE. Based on the radio access technology used by the at least one UE is then instructed to dynamically toggle from voice centricity to data centricity. A confirmation is then received from the at least one UE that the UE has dynamically toggled from voice centricity to data centricity.

By way of background, a traditional telecommunications network employs a plurality of base stations (i.e., nodes, cell sites, cell towers) to provide network coverage. The base stations are employed to broadcast and transmit transmissions to user devices of the telecommunications network. An base station may be considered to be a portion of a base station that may comprise an antenna, a radio, and/or a controller. In aspects, a base station is defined by its ability to communicate with a user equipment (UE), such as a wireless communication device (WCD), according to a single protocol (e.g., 3G, 4G, LTE, 5G, or 6G, and the like); however, in other aspects, a single base station may communicate with a UE according to multiple protocols. As used herein, a base station may comprise one base station or more than one base station. Factors that can affect the telecommunications transmission include, e.g., location and size of the base stations, and frequency of the transmission, among other factors. The base stations are employed to broadcast and transmit transmissions to user devices of the telecommunications network. Traditionally, the base station establishes uplink (or downlink) transmission with a mobile handset over a single frequency that is exclusive to that particular uplink connection (e.g., an LTE connection with an EnodeB). In this regard, typically only one active uplink connection can occur per frequency. The base station may include one or more sectors served by individual transmitting/receiving components associated with the base station (e.g., antenna arrays controlled by an EnodeB). These transmitting/receiving components together form a multi-sector broadcast arc for communication with mobile handsets linked to the base station.

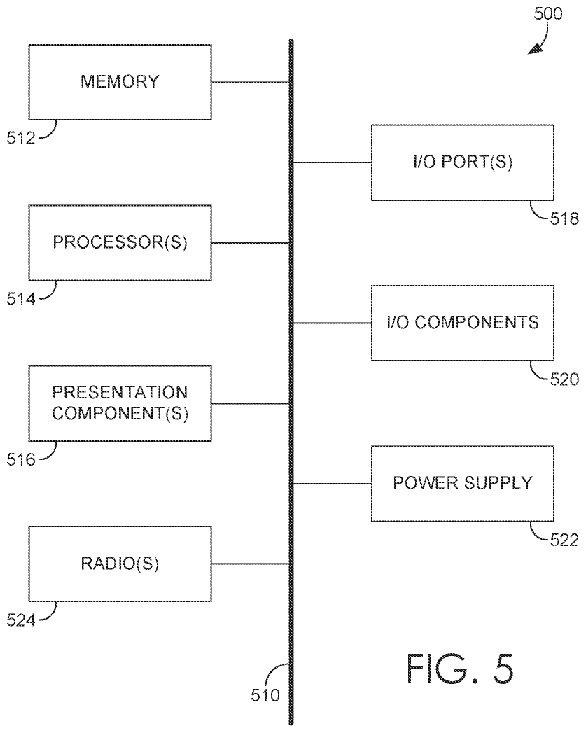

As used herein, “base station” is one or more transmitters or receivers or a combination of transmitters and receivers, including the accessory equipment, necessary at one location for providing a service involving the transmission, emission, and/or reception of radio waves for one or more specific telecommunication purposes to a mobile station (e.g., a UE), wherein the base station is not intended to be used while in motion in the provision of the service. The term/abbreviation UE (also referenced herein as a user device or wireless communications device (WCD)) can include any device employed by an end-user to communicate with a telecommunications network, such as a wireless telecommunications network. A UE can include a mobile device, a mobile broadband adapter, or any other communications device employed to communicate with the wireless telecommunications network. A UE, as one of ordinary skill in the art may appreciate, generally includes one or more antennas coupled to a radio for exchanging (e.g., transmitting and receiving) transmissions with a nearby base station. A UE may be, in an embodiment, similar to device 500 described herein with respect to FIG. 5.

As used herein, UE (also referenced herein as a user device or a wireless communication device) can include any device employed by an end-user to communicate with a wireless telecommunications network. A UE can include a mobile device, a mobile broadband adapter, a fixed location or temporarily fixed location device, or any other communications device employed to communicate with the wireless telecommunications network. For an illustrative example, a UE can include cell phones, smartphones, tablets, laptops, small cell network devices (such as micro cell, pico cell, femto cell, or similar devices), and so forth. Further, a UE can include a sensor or set of sensors coupled with any other communications device employed to communicate with the wireless telecommunications network; such as, but not limited to, a camera, a weather sensor (such as a rain gage, pressure sensor, thermometer, hygrometer, and so on), a motion detector, or any other sensor or combination of sensors. A UE, as one of ordinary skill in the art may appreciate, generally includes one or more antennas coupled to a radio for exchanging (e.g., transmitting and receiving) transmissions with a nearby base station.

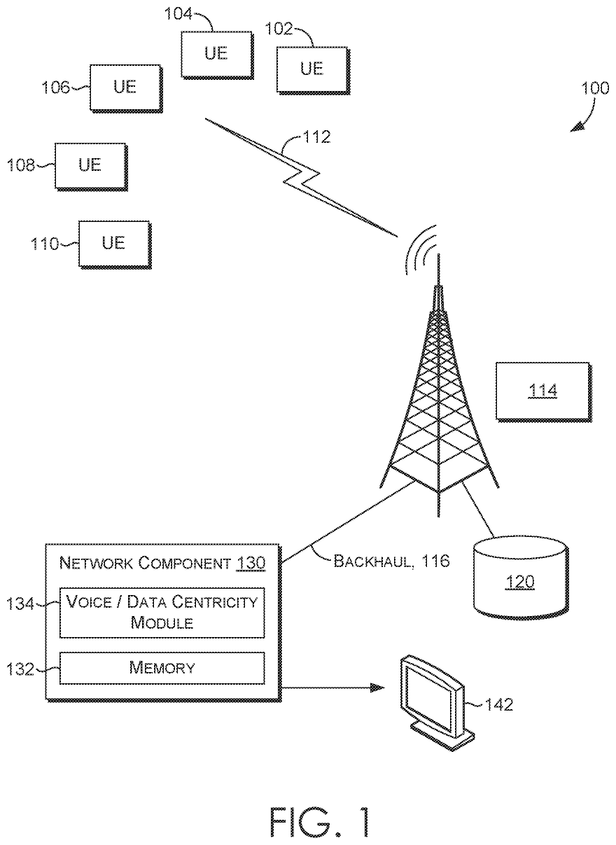

FIG. 1 illustrates an example of a network environment 100 suitable for use in implementing embodiments of the present disclosure. The network environment 100 is but one example of a suitable network environment and is not intended to suggest any limitation as to the scope of use or functionality of the disclosure. Neither should the network environment 100 be interpreted as having any dependency or requirement to any one or combination of components illustrated.

Network environment 100 includes UE devices 102, 104, 106, 108, and 110, base station 114 (which may be a cell site or the like), and one or more communication channels 112. The communication channels 112 can communicate over frequency bands assigned to the carrier. In network environment 100, UE devices may take on a variety of forms, such as a personal computer (PC), a user device, a smart phone, a smart watch, a laptop computer, a mobile phone, a mobile device, a tablet computer, a wearable computer, a personal digital assistant (PDA), a server, a CD player, an MP3 player, a global positioning system (GPS) device, a video player, a handheld communications device, a workstation, a router, a hotspot, an extended reality device, and any combination of these delineated devices, or any other device (such as the computing device (500) that communicates via wireless communications with the base station 114 in order to interact with a public or private network.

In some aspects, each of the UEs 102, 104, 106, 108, and 110 may correspond to computing device 500 in FIG. 5. Thus, a UE can include, for example, a display(s), a power source(s) (e.g., a battery), a data store(s), a speaker(s), memory, a buffer(s), a radio(s) and the like. In some implementations, for example, devices such the UEs 102, 104,106, 108, and 110 comprise a wireless or mobile device with which a wireless telecommunication network(s) can be utilized for communication (e.g., voice and/or data communication). In this regard, the user device can be any mobile computing device that communicates by way of a wireless network, for example, a 3G, 4G, 5G, LTE, 6G, CDMA, or any other type of network.

In some cases, UEs 102, 104, 106, 108, and 110 in network environment 100 can optionally utilize one or more communication channels 112 to communicate with other computing devices (e.g., a mobile device(s), a server(s), a personal computer(s), etc.) through base station 114. Base station 114 may be a gNodeB in a 5G or 6G network.

The network environment 100 may be comprised of a telecommunications network(s), or a portion thereof. A telecommunications network might include an array of devices or components (e.g., one or more base stations), some of which are not shown. Those devices or components may form network environments similar to what is shown in FIG. 1, and may also perform methods in accordance with the present disclosure. Components such as terminals, links, and nodes (as well as other components) can provide connectivity in various implementations. Network environment 100 can include multiple networks, as well as being a network of networks, but is shown in more simple form so as to not obscure other aspects of the present disclosure.

The one or more communication channels 112 can be part of a telecommunication network that connects subscribers to their immediate telecommunications service provider (i.e., home network carrier). In some instances, the one or more communication channels 112 can be associated with a telecommunications provider that provides services (e.g., 3G network, 4G network, LTE network, 5G network, 6G network, and the like) to user devices, such as UEs 102, 104, 106, 108, and 110. For example, the one or more communication channels may provide voice, SMS, and/or data services to UEs 102, 104, 106, 108, and 110, or corresponding users that are registered or subscribed to utilize the services provided by the telecommunications service provider. The one or more communication channels 112 can comprise, for example, a 1× circuit voice, a 3G network (e.g., CDMA, CDMA2000, WCDMA, GSM, UMTS), a 4G network (WiMAX, LTE, HSDPA), a 5G network or a 6G network.

In some implementations, base station 114 is configured to communicate with a UE, such as UEs 102, 104, 106, 108, and 110, that are located within the geographic area, or cell, covered by radio antennas of base station 114. Base station 114 may include one or more base stations, base transmitter stations, radios, antennas, antenna arrays, power amplifiers, transmitters/receivers, digital signal processors, control electronics, GPS equipment, and the like. In particular, base station 114 may selectively communicate with the user devices using dynamic beamforming.

As shown, base station 114 is in communication with a network component 130 and at least a network database 120 via a backhaul channel 116. As the UEs 102, 104, 106, 108, and 110 collect individual status data, the status data can be automatically communicated by each of the UEs 102, 104, 106, 108, and 110 to the base station 114. Base station 114 may store the data communicated by the UEs 102, 104, 106, 108, and 110 at a network database 120. Alternatively, the base station 114 may automatically retrieve the status data from the UEs 102, 104, 106, 108, and 110, and similarly store the data in the network database 120. The data may be communicated or retrieved and stored periodically within a predetermined time interval which may be in seconds, minutes, hours, days, months, years, and the like. With the incoming of new data, the network database 120 may be refreshed with the new data every time, or within a predetermined time threshold so as to keep the status data stored in the network database 120 current. For example, the data may be received at or retrieved by the base station 114 every 10 minutes and the data stored at the network database 120 may be kept current for 30 days, which means that status data that is older than 30 days would be replaced by newer status data at 10 minute intervals. As described above, the status data collected by the UEs 102, 104, 106, 108, and 110 can include, for example, service state status, the respective UE's current geographic location, a current time, a strength of the wireless signal, available networks, and the like.

The network component 130 comprises a memory 132 and a voice/data centricity module 134. The voice/data centricity module 134 determines if a UE may need to switch from voice centricity to data centricity in order to remain on the PLMN the UE may have roamed onto. All determinations, calculations, and data further generated by the voice/data centricity module 134 may be stored at the memory 132 and also at the data store 140. Although the network component 130 is shown as a single component comprising the memory 132 and voice/data centricity module 134, it is also contemplated that each of the memory 132 and voice/data centricity module 134 may reside at different locations, be its own separate entity, and the like, within the home network carrier system.

The network component 130 is configured to retrieve signal information, UE device information, slot configuration, latency information, including quality of service (QoS) information, and metrics from the base station 114 or one of the UE devices 102, 104, 106, 108, and 110. The information may also include radio frequency (RF) signal quality information, such as signal to interference and noise (SINR) ratio. UE device information can include a device identifier and data usage information. The voice/data centricity module 134 may gather UE information such as radio type, type of wireless network the UE may access, UE capabilities, and similar data.

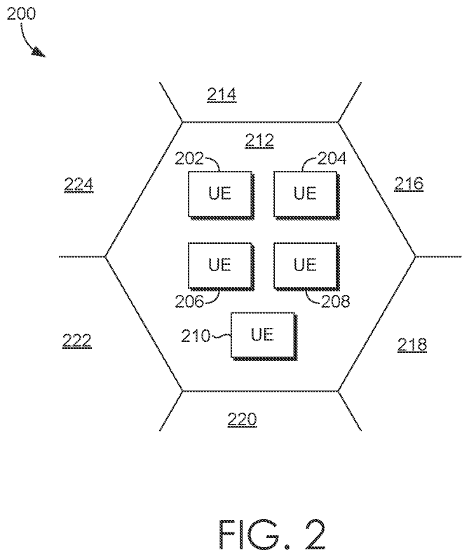

FIG. 2 depicts a cellular network suitable for use in implementations of the present disclosure, in accordance with aspects herein. For example, as shown in FIG. 2, each geographic area in the plurality of geographic areas may have a hexagonal shape such as hexagon representing a geographic area 200 having cells 212, 214, 216, 218, 220, 222, 224, each including base station or base station 114, backhaul channel 116, antenna for sending and receiving signals over communication channels 112, network database 120 and network component 130. The size of the geographic area 200 may be predetermined based on a level of granularity, detail, and/or accuracy desired for the determinations/calculations done by the systems, computerized methods, and computer-storage media. A plurality of UEs may be located within each geographic area collecting UE data within the geographic area at a given time. For example, as shown in FIG. 2, UEs 202, 204, 206, 208, and OBD II module 210, may be located within geographic area 200 collecting UE data that is useable by network component 130, in accordance with aspects herein. UEs 202, 204, 206, 208, and 210 can move within the cell currently occupying, such as cell 212 and can move to other cells such as adjoining cells 214, 216, 218, 220, 222 and 224.

Cellular networks have been deployed worldwide for decades now with users increasingly relying on devices for multiple applications and uses. Older generations of technologies, such as 2G, 3G, 4G, LTE, and 5G may still be in use today and network operators across the globe are in varying stages of technology migration. In addition, operators have roaming agreements to allow customers from one network to roam to a different network. The network the user roams to may be in a different country. Roaming agreements typically cover older technologies such as GSM, UMTS, and may also cover LTE.

When roaming a subscriber attaches to the core network via the access network. The roaming core network is part of a PLMN. Service level roaming capabilities may provide that voice is guaranteed first to be catered as a service and that no data only roaming is possible. This situation arises because UEs have been designed and specified to be voice centric in nature and may also arise because voice calling is a rudimentary service that should always be assured to a customer. This voice centricity was defined in the 3GPP standard and the standard called for voice centric UEs to receive assurances that a visiting PLMN (VPLMN).

Voice centricity may have been necessary when no other calling mechanisms were available. Now, if calling using native voice is not possible a mobile customer may complete an over-the-top (OTT) call using an application on their UE, such as WhatsApp, Facebook Messenger, or similar services. Network operators may now be able to allow UEs to operate with data centricity when data capability is available and voice capability may not be available. Problems may arise if a UE user from a country is visiting another network and the VPLMN has already shut down the older technology the user's UE relies upon. This may occur if the VPLMN has already shut down the 2G or 3G network. As a result, the VPLMN is not able to give assurances to circuit switch based voice calling options, such as circuit switched fallback (CSFB). In CSFB voice and SMS services are delivered to LTE devices through GSM or another circuit switched network. If the UE supports LTE but is not an internet protocol multimedia subsystem (IMS) device the UE may not be able to receive circuit switched service based voice calling options and may be left with no service. IMS devices incorporate a framework that delivers multimedia communications services, such as voice, video, and text messaging over an IP network.

The VPLMN may resolve the problem by dynamic toggling of voice centricity and data centricity. The dynamic toggling may occur if the VPLMN has shut down UMS and GSM services but does provide LTE services. The VPLMN may advise the roaming UE to change from a voice centricity preference to a data centricity preference. This dynamic toggling allows a UE to receive data service, which in turn may allow the UE user to connect to the VPLMN. Dynamic toggling provides benefits to the network operators as it allows them to serve subscribers in a global roaming scenario, provided that mutual roaming agreements are in place. In addition, dynamic toggling may also be useful if a network outage occurs.

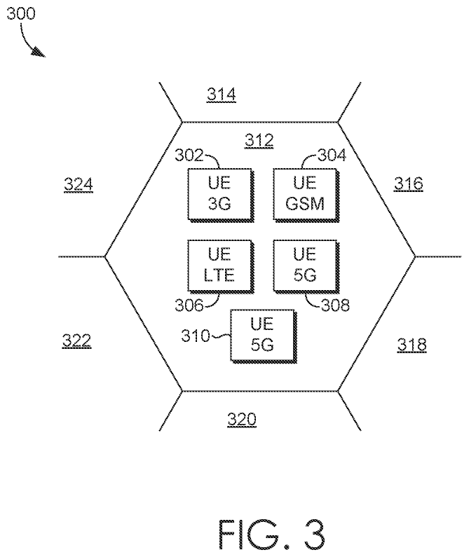

FIG. 3 depicts a cellular network with roaming UEs using different radio technologies, in which implementations of the present disclosure may be employed, in accordance with aspects herein. For example, as shown in FIG. 3, each geographic area in the plurality of geographic areas may have a hexagonal shape such as hexagon representing a geographic area 300 having cells 312, 314, 316, 318, 320, 322, 324, each including base station or base station 114, backhaul channel 116, antenna for sending and receiving signals over communication channels 112, network database 120 and network component 130. The size of the geographic area 300 may be predetermined based on a level of granularity, detail, and/or accuracy desired for the determinations/calculations done by the systems, computerized methods, and computer-storage media. A plurality of UEs may be located within each geographic area collecting UE data within the geographic area at a given time. For example, as shown in FIG. 3, UEs 302, 304, 306, 308, and 310, may be located within geographic area 300 collecting UE data that is useable by network component 130 and voice/data centricity module 134, in accordance with aspects herein. UEs 302, 304, 306, 308, and 310 can move within the cell currently occupying, such as cell 312 and can move to other cells such as adjoining cells 314, 316, 318, 320, 322 and 324.

The UEs may use different radio technologies and may be roaming from another network. For example, UE 302 may be a 3G device, UE 304 may be a GSM device, UE 306 may be an LTE device, UEs 308 and 310 may be 5G devices. UEs 302, 304, and 306 may be roaming from another network and may use the dynamic toggling described herein to make OTT calls using an application loaded on the UE.

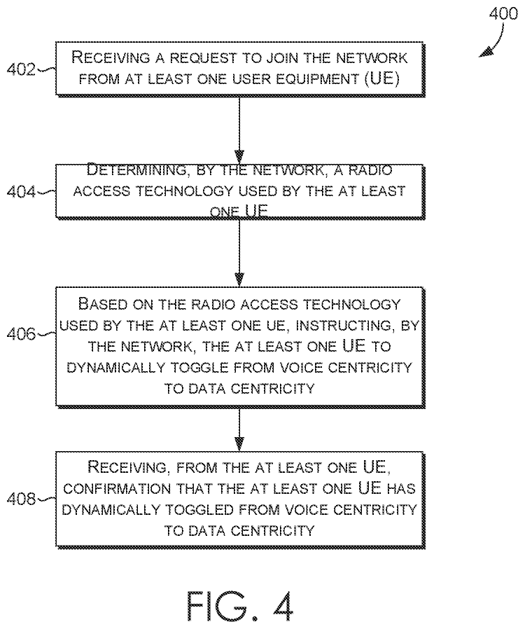

FIG. 4 is a flow diagram of an exemplary method of dynamic toggling of voice centricity and data centricity for roaming UEs, in an exemplary network environment, in which aspects of the present disclosure may be employed, in accordance with aspects herein. The method 400 begins in block 402 when a network receives a request from at least one UE to join the network, wherein the at least one UE is roaming from a home network. In block 404 a radio access technology used by the at least one UE is determined by the network. Then, in block 406, based on the radio access technology used by the at least one UE, the network instructs the at least one UE to dynamically toggle from voice centricity to data centricity. In block 408 the network receives confirmation from the at least one UE that the at least one UE has dynamically toggled from voice centricity to data centricity.

The at least one UE may be roaming from a home network that may use a different radio access technology from the visited network and may be in a different country. The home network may be one of: a GSM network, UMTS network, LTE network, or a network using comparable older radio access technologies. The home network of the UE may be voice centric and the UE may be capable of accessing a data network and may do so through IMS. The access to the data network allows a UE to make an OTT call using an application on the UE.

FIG. 5 depicts an exemplary computing device suitable for use in implementations of the present disclosure, in accordance with aspects herein. With continued reference to FIG. 5, computing device 500 includes bus 502 that directly or indirectly couples the following devices: memory 504, one or more processors 506, one or more presentation components 508, input/output (I/O) ports 512, I/O components 510, radio 516, transmitter 518, and power supply 514. Bus 502 represents what may be one or more busses (such as an address bus, data bus, or combination thereof). Although the devices of FIG. 5 are shown with lines for the sake of clarity, in reality, delineating various components is not so clear, and metaphorically, the lines would more accurately be grey and fuzzy. For example, one may consider a presentation component such as a display device to be one of I/O components 510. Also, processors, such as one or more processors 506, have memory. The present disclosure hereof recognizes that such is the nature of the art, and reiterates that FIG. 5 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 5 and refer to “computer” or “computing device.”

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

Computing device 500 typically includes a variety of computer-readable media. Computer-readable media can be any available media that can be accessed by computing device 500 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 504 includes computer-storage media in the form of volatile and/or nonvolatile memory. Memory 504 may be removable, nonremovable, or a combination thereof. Exemplary memory includes solid-state memory, hard drives, optical-disc drives, etc. Computing device 500 includes one or more processors 506 that read data from various entities such as bus 502, memory 504 or I/O components 510. One or more presentation components 508 present data indications to a person or other device. Exemplary one or more presentation components 508 include a display device, speaker, printing component, vibrating component, etc. I/O ports 512 allow computing device 500 to be logically coupled to other devices including I/O components 510, some of which may be built into computing device 500. Illustrative I/O components 510 include a microphone, joystick, game pad, satellite dish, scanner, printer, wireless device, etc.

The radio 516 represents one or more radios that facilitate communication with a wireless telecommunications network. While a single radio 516 is shown in FIG. 5, it is contemplated that there may be more than one radio 516 coupled to the bus 502. In aspects, the radio 516 utilizes a transmitter 518 to communicate with the wireless telecommunications network. It is expressly conceived that a computing device with more than one radio 516 could facilitate communication with the wireless telecommunications network via both the first transmitter 518 and an additional transmitters (e.g. a second transmitter). Illustrative wireless telecommunications technologies include CDMA, GPRS, TDMA, GSM, and the like. The radio 516 may additionally or alternatively facilitate other types of wireless communications including Wi-Fi, WiMAX, LTE, 3G, 4G, LTE, 5G, 6G, NR, VoLTE, or other VoIP communications. As can be appreciated, in various embodiments, radio 516 can be configured to support multiple technologies and/or multiple radios can be utilized to support multiple technologies. A wireless telecommunications network might include an array of devices, which are not shown so as to not obscure more relevant aspects of the invention. Components such as a base station, a communications tower, or even base stations (as well as other components) can provide wireless connectivity in some embodiments.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The invention claimed is:

1. A method of dynamic toggling between voice centricity and data centricity in a network, the method comprising:
receiving a request to join the network from at least one user equipment (UE);
determining, by the network, a radio access technology used by the at least one UE;
based on the radio access technology used by the at least one UE, instructing, by the network, the at least one UE to dynamically toggle from voice centricity to data centricity; and
receiving, from the at least one UE, confirmation that the at least one UE has dynamically toggled from voice centricity to data centricity.

2. The method of claim 1, wherein the at least one UE is roaming from a home network.

3. The method of claim 2, wherein the home network supports a different radio access technology from the network.

4. The method of claim 3, wherein the home network radio access technology is at least one of: global system for mobile communications (GSM), universal mobile telecommunication system (UMTS), or long term evolution (LTE).

5. The method of claim 3, wherein the radio access technology supported by the home network is voice centric.

6. The method of claim 1, further comprising accessing, by the at least one UE, a data network after toggling to data centric operation.

7. The method of claim 6, further comprising accessing, by the at least one UE an over-the-top application after accessing the data network.

8. A method of dynamic toggling between voice centricity and data centricity in a network, the method comprising:
transmitting a request to join the network from a user equipment (UE), wherein the request includes information on a radio access technology used by the UE;
based on the radio access technology used by the UE, receiving, by the UE, an instruction to dynamically toggle from voice centricity to data centricity; and
transmitting, to the network, a confirmation that the UE has dynamically toggled from voice centricity to data centricity.

9. The method of claim 8, wherein the UE is roaming from a home network.

10. The method of claim 9, wherein the home network supported a different radio access technology from the network.

11. The method of claim 10, wherein the radio access technology used by the UE is at least one of: global system for mobile communications (GSM), universal mobile telecommunications service (UMTS), or long term evolution (LTE).

12. The method of claim 10, wherein the radio access technology supported by the home network is voice centric.

13. The method of claim 9, further comprising, accessing, by the UE, a data network after toggling to data centric operation.

14. The method of claim 13, further comprising accessing, by the UE an over-the-top application after toggling to data centric operation.

15. The method of claim 14, further comprising completing a voice call using the over-the-top application.

16. A non-transitory computer storage media storing computer-useable instructions that, when used by one or more processors, cause the processors to:
receive a request to join a network from at least one user equipment (UE);
determine, by a network, a radio access technology used by the at least one UE;
instruct, based on the radio access technology used by the at least one UE, the at least one UE to dynamically toggle from voice centricity to data centricity; and
receive, from the at least one UE, a confirmation that the at least one UE has dynamically toggled from voice centricity to data centricity.

17. The non-transitory computer storage media of claim 16, wherein the at least one UE is roaming from a home network that supports a different radio access technology from the network.

18. The non-transitory computer storage media of claim 17, wherein the home network radio access technology is at least one of: global system for mobile communications (GSM), universal mobile telecommunication system (UMTS), or long term evolution (LTE).

19. The non-transitory computer storage media of claim 18, wherein the radio access technology support by the home network is voice centric.

20. The non-transitory computer storage media of claim 19, further comprising access, by the UE, a data network after toggling to data centric operation.
